(19) United States
(12) Patent Application Publication
(10) Pub. No.: US 2008/0212050 A1
(43) Pub. Date: Sep. 4, 2008

(54) Apparatus and methods for removing immersion liquid from substrates using temperature gradient

(75) Inventors: Alex Ka Tim Poon, San Ramon, CA (US); Leonard Wai Fung Kho, San Francisco, CA (US); Gaurav Keswani, Fremont, CA (US); Derek Coon, Redwood City, CA (US); Soichi Owa, Kumagawa-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/068,077

(22) Filed: Feb. 1, 2008

Related U.S. Application Data
(60) Provisional application No. 60/899,632, filed on Feb. 6, 2007.

(51) Int. Cl. G03B 27/52

(52) U.S. Cl. 355/30

(57) ABSTRACT

Apparatus and methods assist in the removal of immersion liquid from a surface of a substrate. In particular, the apparatus/method removes immersion liquid from a surface of a substrate that has been subjected to immersion lithographic exposure. A temperature control unit controls a temperature of the substrate to create a temperature gradient across at least a portion of the surface of the substrate such that a first portion of the surface of the substrate has a first temperature that is higher than a second temperature of a second portion of the surface of the substrate. The temperature gradient induces the immersion liquid remaining on the substrate to move from the higher temperature portion(s) toward the lower temperature portion(s).

### RELATED APPLICATION

This application claims the benefit of U.S. Provisional Patent Application No. 60/899,632 filed Feb. 6, 2007. The disclosure of U.S. Provisional Patent Application No. 60/899,632 is incorporated herein by reference in its entirety.

### BACKGROUND

The invention relates to immersion lithography, and in particular to apparatus and methods for removing immersion liquid from objects such as substrates.

Immersion lithography is a technique that can enhance the resolution of lithographic exposure apparatus by permitting exposure to take place with a numerical aperture (NA) that is greater than the NA that can be achieve in conventional “dry” lithographic exposure apparatus. By filling the space between the final optical element of the projection system and the resist-coated substrate, immersion lithography permits exposure with light that would otherwise be internally reflected at the optic-air interface. Numerical apertures as high as the index of the immersion fluid (or of the resist or lens material, whichever is least) are possible in immersion lithographic systems. Liquid immersion also increases the substrate depth-of-focus, that is, the tolerable error in the vertical position of the substrate, by the index of the immersion fluid compared to a dry system having the same numerical aperture.

Various liquids can be used as the immersion liquid in immersion lithographic apparatus. For example, it is common to use purified water as the immersion liquid. Other liquids such as cedar oil, fomblin oil, fluorin-based oils, “Decalin” or “Perhydropyrene,” bicyclohexyl, hexane, etc. can be used as the immersion liquid. Ideally, the immersion liquid should have as high of an index of refraction as possible while remaining transparent to the irradiation beam used to expose the resist on the substrate.

It is important to ensure that the immersion liquid is completely removed from the substrate after the substrate is exposed. Immersion liquid remaining on the substrate can contaminate the exposure apparatus, as well as other apparatus that are used to process the substrate after exposure. In addition, evaporation of the immersion liquid remaining on a substrate can interfere with the accuracy achieved by the exposure apparatus or by other apparatus that process the substrate after exposure. Even if the exposure liquid does not evaporate, the presence of the immersion liquid also can interfere with processes such as developing, etc., that are performed on the substrate after the substrate has been exposed. Accordingly, it is important to completely remove immersion liquid from substrates after they have been exposed in an immersion lithographic apparatus. Furthermore, some high index-of-refraction immersion liquids can be more difficult to remove from substrates due to the high surface tension these liquids have with respect to the substrate surface.

### SUMMARY

Aspects of the invention relate to apparatus and methods for assisting in the removal of immersion liquid from a surface of a substrate.

In accordance with some aspects of the invention, an apparatus removes immersion liquid from a surface of a substrate that has been subjected to immersion lithographic exposure. The apparatus includes a temperature control unit that controls a temperature of the substrate to create a temperature gradient across at least a portion of the surface of the substrate such that a first portion of the surface of the substrate has a first temperature that is higher than a second temperature of a second portion of the surface of the substrate. The apparatus also can include a liquid collection unit that collects the immersion liquid from the substrate.

By creating a temperature gradient across the surface of the substrate, the immersion liquid remaining on the substrate surface tends to move from the high temperature area toward the low temperature area, which makes it easier to collect all the immersion liquid from the substrate surface.

According to some embodiments, the liquid collection unit is disposed adjacent to the second (lower temperature) portion of the substrate to collect the immersion liquid from the second portion of the substrate.

According to some embodiments, the temperature control unit includes a heating unit, and the temperature control unit controls the temperature of the substrate by heating the first portion with the heating unit. According to other embodiments, the temperature control unit controls the temperature of the substrate by cooling the second portion of the substrate with a cooling unit. Inducing a temperature gradient across the substrate surface by heating and/or cooling one or more portions of the substrate creates a tractive force from the higher temperature region(s) toward the lower temperature region(s), which causes immersion liquid remaining on the substrate surface to move toward the lower temperature region(s).

According to some embodiments, a higher temperature region is created on one side of the substrate so that the immersion liquid moves from that side toward an opposite side of the substrate. By providing a liquid collection unit adjacent to the opposite (lower temperature) side of the substrate, the liquid is collected. According to other embodiments, the higher temperature portion is created near a center of the substrate, which causes the immersion liquid to move away from the center of the substrate toward the periphery of the substrate. By providing a liquid collection unit adjacent to the periphery of the substrate, the liquid is collected.

According to some embodiments, the substrate is held by a substrate holder, and a heating (and/or cooling) unit is disposed in the holder so as to apply heat to a portion of the surface of the substrate (and/or so as to remove heat from a portion of the surface of the substrate by cooling) so as to induce the temperature gradient across the substrate surface.

Additional devices can be provided to assist in removing the liquid from the substrate surface. For example, a blower can be provided to blow gas onto the substrate so as to assist in removal of the liquid from the substrate. The blowing can be aimed to assist in moving the liquid from the high temperature portion toward the low temperature portion. According to other embodiments, the liquid can be removed by spinning the substrate or by tilting the substrate. For example, when the center of the substrate is heated to induce movement toward the periphery of the substrate, spinning can further assist in removing the liquid from the substrate surface. If a temperature gradient is induced from one side toward the opposite side of the substrate, tilting the substrate can further assist in removal of immersion liquid from the substrate surface.

The immersion liquid removal apparatus can be provided within a lithographic exposure apparatus or can be provided separate from the exposure apparatus. For example, the immersion liquid removal apparatus can be provided between an exposure apparatus and a processing apparatus such as a substrate coating/developing apparatus.

### BRIEF DESCRIPTION OF THE DRAWINGS

The invention will be described in conjunction with the following drawings of exemplary embodiments in which like reference numerals designate like elements, and in which:

FIG. 1 is a simplified diagram of a liquid removal apparatus according to a first embodiment;

FIG. 2 shows the temperature gradient induced in the substrate of the FIG. 1 embodiment;

FIG. 3 is a simplified diagram of a liquid removal apparatus according to a second embodiment;

FIG. 4 illustrates the temperature gradient induced in the substrate in the second embodiment;

FIG. 5 is a plan view of a substrate having a temperature gradient induced therein according to the second embodiment;

FIG. 6 is a simplified diagram of a modified version of the FIG. 1 liquid removal apparatus in which the substrate holder can be tilted and can have a gas blown onto the held substrate;

FIG. 7 is a simplified diagram of a modified version of the FIG. 3 liquid removal apparatus in which the substrate holder can be subjected to spinning and a gas can be blown onto the held substrate;

FIG. 8 is a simplified diagram of an immersion lithographic apparatus to which the various aspects of the invention can be applied;

FIG. 9 is a simplified diagram of a substrate processing system in which the liquid removal apparatus according to aspects of the invention can be included in a chamber that includes an immersion lithographic apparatus;

FIG. 10 is a simplified diagram of another substrate processing system in which the liquid removal apparatus according to aspects of the invention can be included between a chamber holding an exposure apparatus and a second chamber holding a substrate processing apparatus such as, for example, a coater/developer; and

FIGS. 11A and 11B are flow diagrams illustrating a sequence of fabricating semiconductor devices according to aspects of the invention.

### DETAILED DESCRIPTION OF EMBODIMENTS

As noted earlier, it is highly desirable to remove all immersion liquid from a substrate after it has been subjected to immersion lithographic exposure in an immersion lithographic apparatus. Furthermore, when an immersion liquid having a high index of refraction is used, the surface tension between that high index immersion liquid and the substrate tends to make the immersion liquid adhere to the substrate, making it more difficult to remove all of the liquid from the surface of the substrate after exposure of the substrate. The inventors have discovered that by heating and/or cooling portions of the substrate so as to generate a temperature gradient across at least a portion of the substrate surface, the immersion liquid remaining on the surface is attracted from the higher temperature areas toward the lower temperature areas. This “tractive” force is utilized to remove, or at least assist in the removal of, immersion liquid remaining on the substrate surface.

While the embodiments illustrated in the drawings use heating to generate the temperature gradient across portions of the substrate, a cooling unit could be used to selectively cool portions of the substrate so as to generate the temperature gradient. Furthermore, the combination of heating and cooling of different portions of the substrate also can be used to generate the temperature gradient.

In addition, the illustrated embodiments provide a separate liquid removal apparatus having its own substrate holder for performing the heating and/or cooling of the substrate. However, the heating and/or cooling could be implemented in the substrate stage of the exposure apparatus that holds the substrate during immersion exposure. Such a modification, however, is less preferable because it makes the substrate stage more complicated and heavy. This makes it more complicated to precisely control the movement of the substrate stage, which is required during exposure of the substrate. Thus, according to the preferred, illustrated embodiments, the liquid removal apparatus is separate from the substrate stage that holds the substrate during exposure.

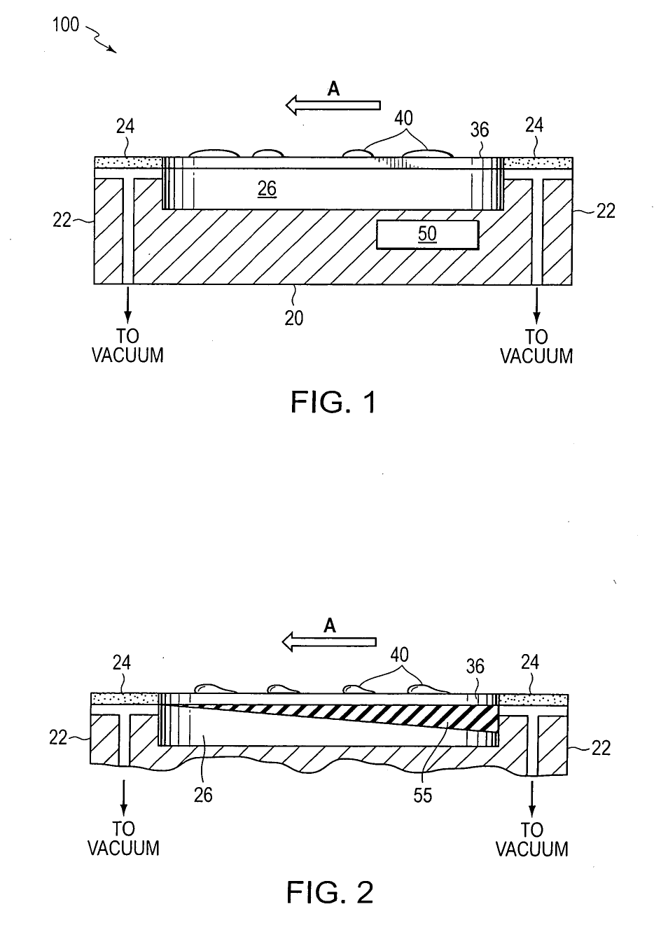

FIG. 1 is a diagram of a liquid removal apparatus 100 according to a first embodiment of the invention. As shown in FIG. 1, a substrate 26, for example, a silicon wafer used to fabricate semiconductor devices or a glass or quartz plate used to fabricate a flat panel display, contains a photoresist 36 on one surface (the upper surface in FIG. 1). The substrate 26 is held by a substrate holder 20. The substrate holder 20 includes a substrate holding area (or substrate chuck) which can be, for example, a recess formed in the holder 20 so as to receive the substrate 26. A vacuum can be supplied to the recess so as to hold the substrate 26 to the holder 20. A liquid collection unit 22 is provided around the periphery of the substrate 26 held by the substrate holder 20.

In the FIG. 1 embodiment, the liquid collection unit 22 completely surrounds the substrate 26 held by the holder 20. The liquid collection unit 22 includes a chamber to which a vacuum is applied as shown in FIG. 1. An upper portion of the chamber includes a porous member 24. Liquid that is removed from the surface of the substrate 26 (the liquid is removed from the resist 36 on the substrate 26), is collected by the porous member 24 disposed in the chamber of the collection unit. The collected liquid then can be removed from the chamber by applying a vacuum to the chamber. The vacuum can be applied continuously or intermittently. One example of structure suitable for forming the liquid collection unit is described in U.S. Patent Application Publication No. 2005/0219488, the entire disclosure of which is incorporated herein by reference.

As shown in FIG. 1, areas of immersion liquid 40 remain on the resist 36 coated side of substrate 26. The liquid removal apparatus 100 of FIG. 1 includes a heating unit 50 disposed in the substrate holder 20. The heating unit 50 is located on one side (the right side in FIG. 1) of the area below the substrate 26. Accordingly, when activated, the heating unit 50 will heat the right side of the substrate to a temperature that is higher than a temperature of the left side of the substrate. Accordingly, portions of the substrate surface on the right side will have a higher temperature than portions on the left side. This will create a tractive force across the surface of the substrate 26 so that the remaining immersion liquid 40 moves in the direction of arrow A in FIG. 1. That is, the liquid moves from the higher temperature side toward the lower temperature side (from right to left in FIG. 1).

In the FIG. 1 embodiment, the heating unit 50 can include heating coils that generate heat when current is passed therethrough. Thus, the substrate 26 is heated by conduction from below. The substrate could be heated by radiant heat from above, for example, by providing a lamp above the substrate in the liquid removal apparatus. Other heating devices that could be used include, but are not limited to, passing a hot liquid through the substrate table that supports the substrate, blowing a hot gas onto the substrate, and/or heating the substrate with an infrared lamp, for example.

FIG. 2 illustrates the temperature gradient 50 induced in the substrate 26. The shaded portion 55 illustrates the temperature of that portion of the substrate. The larger the shaded portion in the vertical direction, then the higher the temperature of that portion. Thus, FIG. 2 illustrates that the right side of the substrate has a higher temperature than the left side, with the temperature gradually decreasing from right-to-left.

As an alternative to using the heating unit 50, a cooling unit could be provided in the substrate holder 20 so as to cool a portion (for example, the left side) of the surface of substrate 26. Another alternative would be to provide a heating unit on one side (for example, the right side) of the holder 20 and to provide a cooling unit on the other side (for example, the left side) of the holder 20. One advantage of this embodiment would be that a relatively large temperature gradient can be generated across the substrate without applying a large amount of heat to the substrate. For example, a 20° C. gradient could be generated by cooling one side to reduce its temperature by 10° C. and by heating the other side to increase its temperature by 10° C., rather than heating only one side of the substrate to increase its temperature by 20° C. Excessive heating of the substrate can damage the layers formed on the substrate.

It is desirable to heat and/or cool portions of the substrate such that a temperature gradient of about 30° C. is generated across the substrate. It is preferable to generate a temperature gradient of 30° C. across the substrate, although a gradient of 20° C. or even 10° C. will assist in removing the immersion liquid from the substrate surface. In general, any temperature gradient will assist in removing the immersion liquid from the substrate, although the larger the gradient, the more assistance in removing immersion liquid is provided. However, the temperature of the immersion liquid should be kept below the flashpoint of the immersion liquid to reduce the chances of combustion. Because some of the immersion liquids are organic and flammable in nature, the temperature usually should be kept below about 50° C. Because machine temperatures of the exposure apparatus are typically about 20° C., a practical range for the temperature gradient is about 30° C.

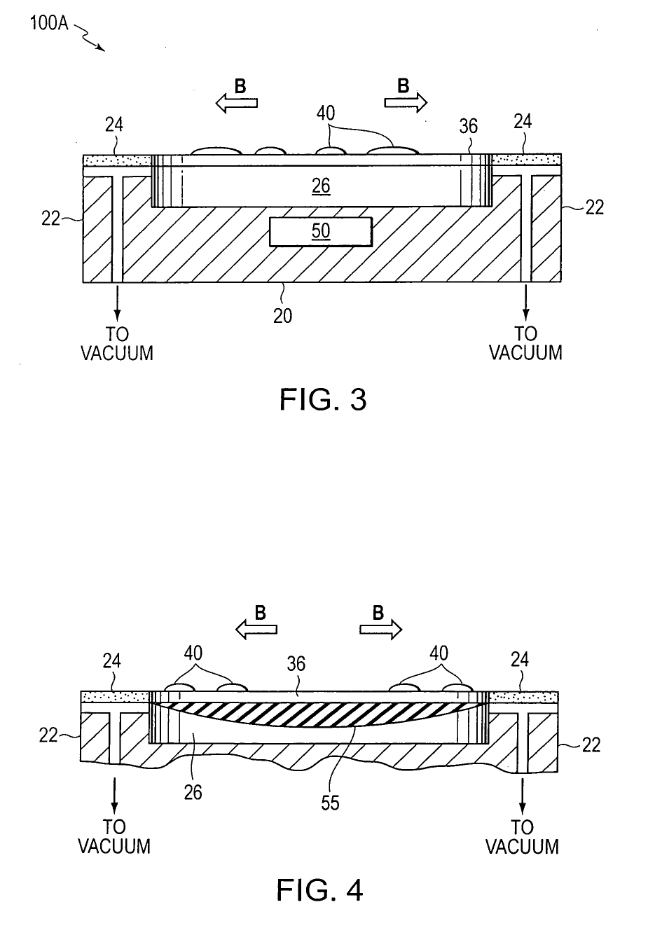

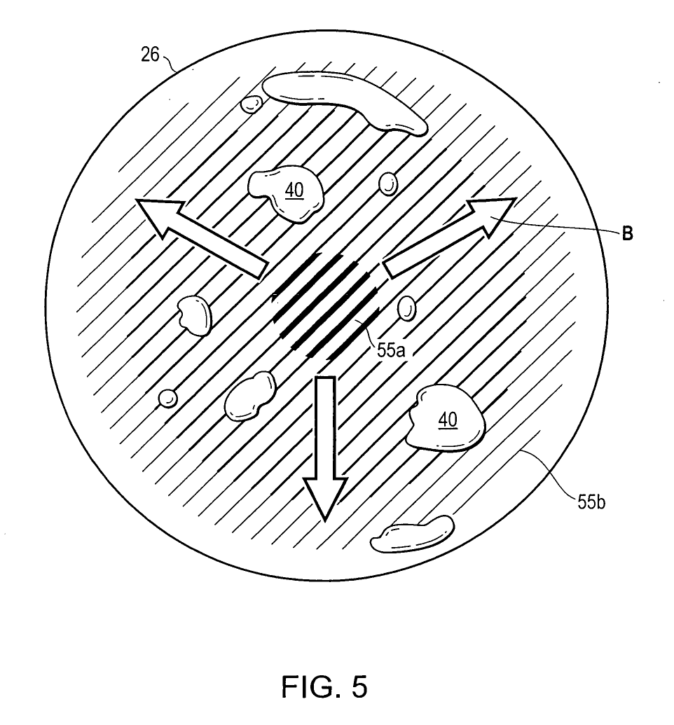

FIG. 3 shows a second embodiment of a liquid removal apparatus 100A. The FIG. 3 embodiment is similar to the FIG. 1 embodiment except that the heating unit 50 is located so that it will heat a central portion of the substrate 26. The FIG. 3 embodiment will create the temperature gradient 55 shown in FIG. 4. In particular, the central portion of the substrate 26 will have a higher temperature than the peripheral portions of the substrate 26. The temperature gradient 55 in FIG. 4 will cause the immersion liquid to move from a central portion of the substrate toward the substrate periphery as illustrated by the arrows B in FIG. 4. FIG. 5 is a plan view of the substrate shown in FIG. 4. FIG. 5 shows the remaining immersion liquid 40 moving radially outward from central, high temperature portion 55a toward radially outer, lower temperature portion 55b, as shown by arrows B. The FIG. 3 embodiment is particularly advantageous in moving the immersion liquid toward the outer periphery of the substrate 26 and then into the collection unit 22.

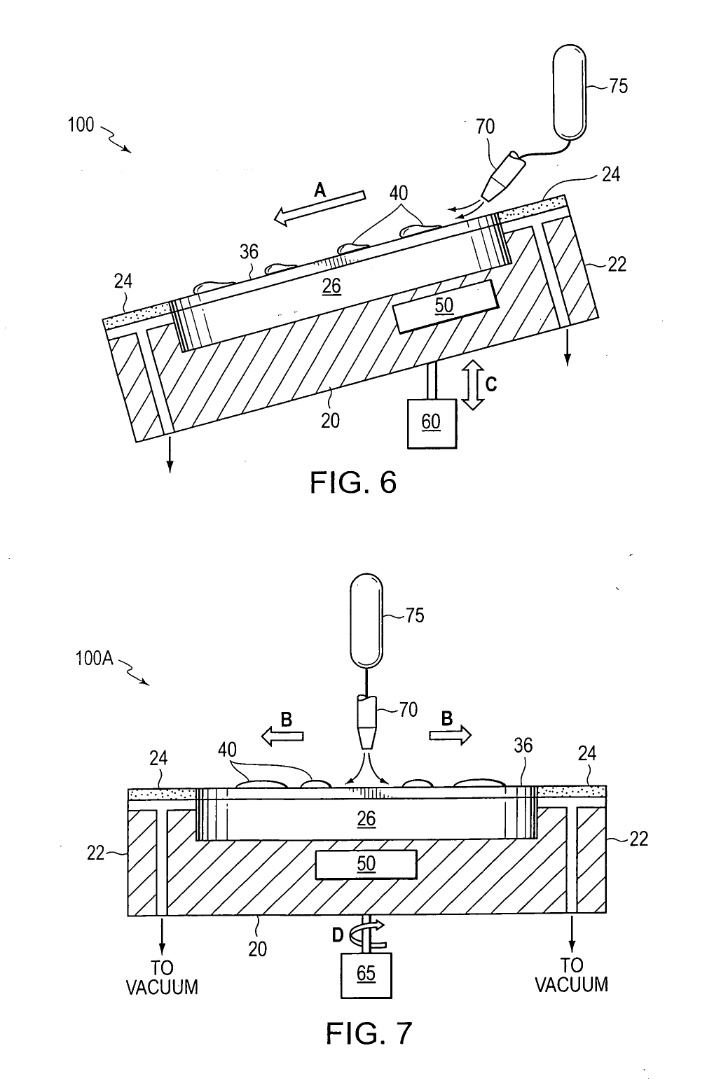

FIG. 6 shows a modification of the FIG. 1 embodiment. In FIG. 6, an actuator 60 is provided so as to incline (tilt) the substrate holder 20 to further assist in removal of liquid from the substrate surface. In addition, a blowing unit including a source of high pressure gas 75 and one or more nozzles 70 is provided to further assist in removal of immersion liquid from the substrate surface. The actuator 60 moves the substrate holder 20 in the directions of arrow C so as to lift the higher temperature side of the substrate 26 to a height that is higher than the lower temperature side of the substrate 26. This further induces movement of the immersion liquid 40 from right-to-left in FIG. 6. The nozzle 70 is arranged to blow a clean gas onto the substrate surface to further assist in movement of immersion liquid 40 from right-to-left. According to modified embodiments, only the actuator 60 is provided (along with the heating unit 50), or only the blowing unit is provided (along with the heating unit 50).

FIG. 7 illustrates a modification of the FIG. 3 embodiment. As with the FIG. 3 embodiment, the heating unit 50 heats the central portion of the substrate 26. An actuator 65 is provided to spin the substrate holder 20 and the substrate 26 about a vertical axis so as to further assist in removal of immersion liquid 40 from the substrate surface. Spinning of the substrate 26 will further assist in movement of immersion liquid radially outward toward the circumference of the substrate 26. The FIG. 7 embodiment also includes a blowing unit including the gas source 75 and one or more nozzles 70. In the FIG. 7 embodiment, the one or more nozzles 70 are disposed to blow gas onto the central portion of the substrate, thereby facilitating radially outward movement of immersion liquid toward the substrate periphery. Of course, the blowing unit could be provided with the heating unit 50, but without the actuator set 65 for spinning. Similarly, the actuator 65 for spinning could be provided with the heating unit 50, but without the blowing unit.

U.S. Patent Application Publication No. 2005/0225735, the entire disclosure of which is incorporated herein by reference, describes a liquid-removing unit disposed between an exposure apparatus and a coater-developer and that removes liquid from a substrate by moving the substrate (for example, by spinning the substrate or inclining the substrate) or by blowing a gas against the substrate. The liquid-removing unit described in U.S. Patent Application Publication No. 2005/0225735 can be used in conjunction with the temperature gradient generating structure described herein to form the liquid removal apparatus according to some embodiments of the invention.

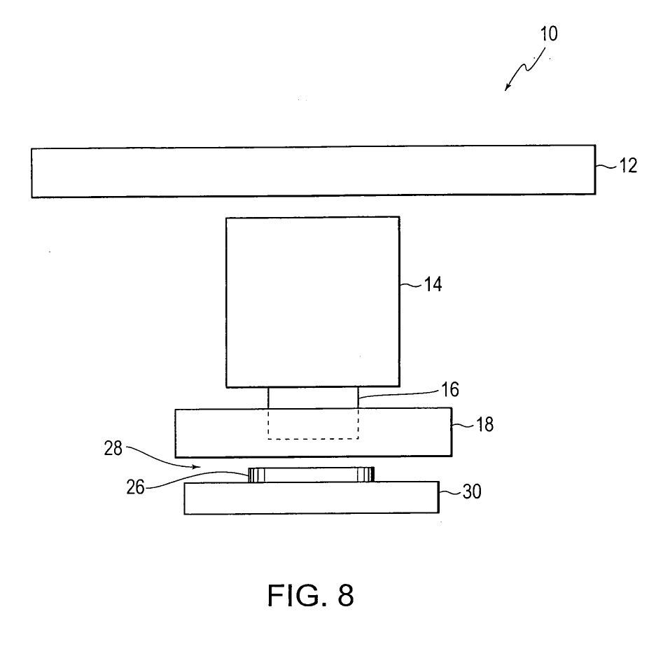

The liquid removal apparatus described herein is used as part of an immersion exposure system so as to remove liquid from a surface of a substrate after that substrate has been subjected to liquid immersion exposure. FIG. 8 illustrates one type of liquid immersion lithographic apparatus with which the liquid removal apparatus according to embodiments of the invention can be used. Although the FIG. 8 immersion lithographic apparatus performs “localized” immersion exposure, in which an immersion liquid is confined to a relatively small area between the last optical element of a projection system and a substrate that is the object of exposure, with the immersion area being smaller than the substrate surface that is subjected to exposure, such that a portion of the substrate surface adjacent to the immersion area is not covered with immersion liquid, the invention also is applicable to immersion lithographic apparatus in which the entire surface of the substrate is covered in immersion liquid during the exposure process. Such apparatus can include a liquid containment plate that forms a space between the plate and the entire upper surface of the substrate so as to contain the immersion liquid between the plate and the entire upper surface of the substrate during the exposure process.

The FIG. 8 immersion lithographic apparatus 10 includes a reticle stage 12 on which a reticle (mask) is supported, a projection system 14 having a last or “final” optical element 16 and a substrate 26 supported on a substrate stage 30. The substrate stage 30 typically includes a substrate-holding table having a wafer chuck to hold the substrate. The substrate-holding table is finely adjustable in the vertical (Z) direction, in the X and Y directions (which are perpendicular to each other and perpendicular to the Z direction) and in the θX, θY and θZ directions with a high degree of precision. The substrate-holding table is mounted on a coarse-movement stage that moves the substrate-holding table and the held substrate 26 in relatively large movement directions in the X, Y, Z, θX, θY and θZ directions. An immersion fluid supply and recovery apparatus 18, sometimes referred to herein as an immersion fluid supply and recovery nozzle, is disposed around the final optical element 16 of the projection system 14 so as to provide and recover the immersion fluid, which may be a liquid as described above, to/from a gap 28 between the final optical element 16 and the substrate 26. In the present embodiment, the immersion lithographic apparatus 10 is a scanning lithographic apparatus in which the reticle and substrate 26 are moved synchronously in respective scanning directions during a scanning exposure operation. The application also is applicable to a step-and-repeat exposure apparatus in which the reticle and substrate are stationary during transfer of the pattern onto the substrate.

The illumination source of the lithographic apparatus can be a light source such as, for example, a mercury g-line source (436 nm) or i-line source (365 nm), a KrF excimer laser (248 nm), an ArF excimer laser (193 nm) or a F₂ laser (157 nm). The projection system 14 projects and/or focuses the light passing through the reticle onto the substrate 26. Depending on the design of the exposure apparatus, the projection system 14 can magnify or reduce the image illuminated on the reticle. It also could be a 1× magnification system.

When far ultraviolet radiation such as from the excimer laser is used, glass materials such as quartz and fluorite that transmit far ultraviolet rays can be used in the projection system 14. The projection system 14 can be a catadioptric, completely refractive or completely reflective system.

The immersion fluid supply and recovery apparatus 18 supplies immersion liquid to a portion of the gap 28 disposed between the last optical-element 16 and the upper surface of the substrate 26. The area where the immersion liquid is supplied can be referred to as an immersion area. The immersion area has a size that is smaller than the surface of the substrate 26, and thus can be referred to as a localized area. The immersion fluid supply and recovery apparatus also collects immersion fluid so that the immersion fluid is continuously (or substantially continuously) supplied to and recovered from the immersion area so as to provide a flow of fresh immersion fluid to that area. The immersion fluid is precisely temperature-controlled and filtered so as to remove particles and gas bubbles. Various structures can be provided as the immersion fluid supply and recovery apparatus 18. See, for example, US2005/0219488A1, US2006/0023181A1 and US2006/0038968A1, the disclosures of which are incorporated herein by reference in their entireties.

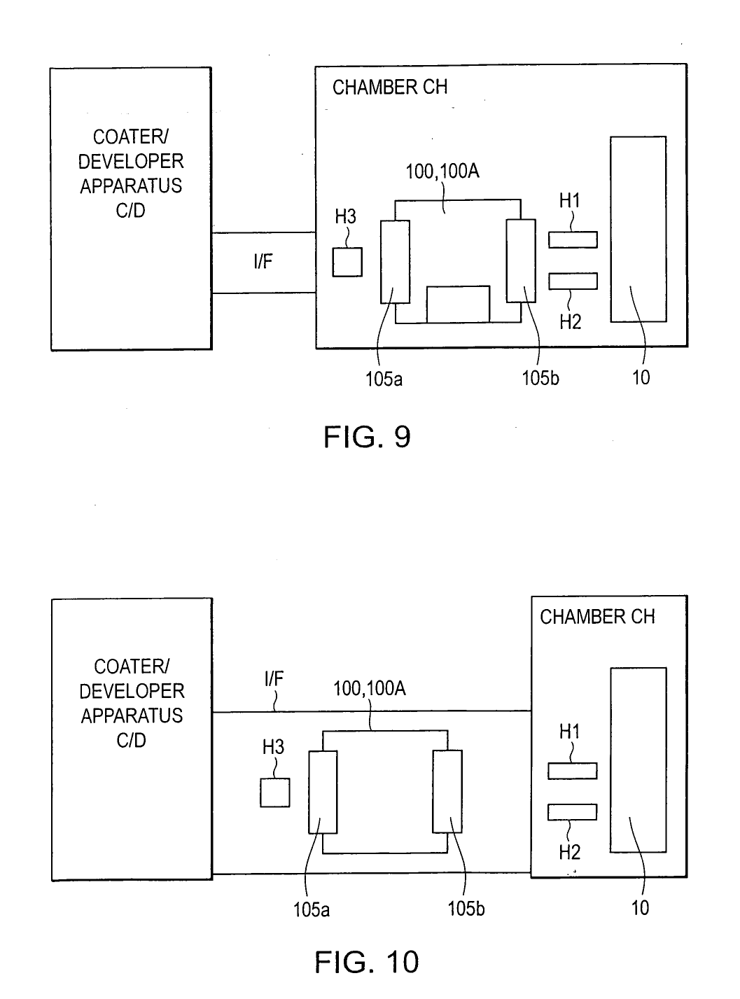

FIG. 9 shows an exposure system according to some embodiments of the invention. The FIG. 9 exposure system has a chamber CH that is linked to a coater-developer apparatus C/D. An interface section IF links the chamber CH of the exposure system to the coater-developer apparatus C/D. The chamber CH contains an exposure apparatus 10, for example, the exposure apparatus 10 described with respect to FIG. 8, and a liquid removal apparatus, such as one of the liquid removal apparatus 100, 100A described with respect to FIGS. 1, 3, 6 and 7. The liquid removal apparatus includes a housing as illustrated in FIG. 9 having doors or shutters 105a and 105b that are selectively opened and closed to allow a substrate to be placed into and/or removed from the liquid removal apparatus. The housing prevents immersion liquid that is removed from the substrate from contaminating the chamber CH, which should be precisely temperature and humidity controlled. The system also includes transport mechanisms H1, H2 and H3 to be described below.

Each of the transport mechanisms H1-H3 can be, for example, a robot arm. Transport mechanism H1 is used to transport exposed substrates, which may have immersion liquid on their surface, from the exposure apparatus 10 to the liquid removal apparatus 100, 100A. After liquid removal apparatus 100, 100A is used to remove liquid from the substrate, the substrate may be passed back to the exposure apparatus 10 or the substrate may be passed to the coater-developer C/D. If the substrate is to be returned to the exposure apparatus 10, it is preferable to use a different handling mechanism H2 to move the substrate from liquid removal apparatus 100, 100A back to the exposure apparatus 10. In this manner, if mechanism H1 is contaminated with liquid from moving the substrate from the exposure apparatus 10, that liquid will not contact a dry substrate that has been dried by liquid removal apparatus 100, 100A. If the substrate dried by liquid removal apparatus 100, 100A is to undergo processing by the coater-developer C/D, then handling mechanism H3 is used to transport the dried substrate from liquid removal apparatus 100, 100A, through interface IF to the coater-developer C/D.

The coater-developer C/D includes a coating unit which coats a base member of the substrate 26 to be subjected to the exposure process with a photoresist (photosensitive agent), and a developing unit (processing unit) which performs the developing process for a substrate 26 after it has been subjected to the exposure process by the exposure apparatus 10.

US2005/0225735, the entire disclosure of which is incorporated herein by reference, describes a system with an architecture similar to what is shown in FIG. 9, but without the temperature gradient creating apparatus described in conjunction with FIGS. 1-7. Thus, the system described in US2005/0225735 can be modified to include the temperature gradient creating structure in the liquid-removing unit described in that publication.

As an alternative to the FIG. 9 arrangement, the liquid removal apparatus 100, 100A can be disposed within the interface IF as shown in FIG. 10, rather than in the chamber CH in which the exposure apparatus 10 is disposed. This arrangement can further reduce contamination of the environment of the chamber CH and can reduce the size of that chamber.

The use of the exposure apparatus described herein is not limited to a photolithography system for semiconductor manufacturing. The exposure apparatus, for example, can be used as an LCD photolithography system that exposes a liquid crystal display device pattern onto a rectangular glass plate, or a photolithography system for manufacturing a thin film magnetic head.

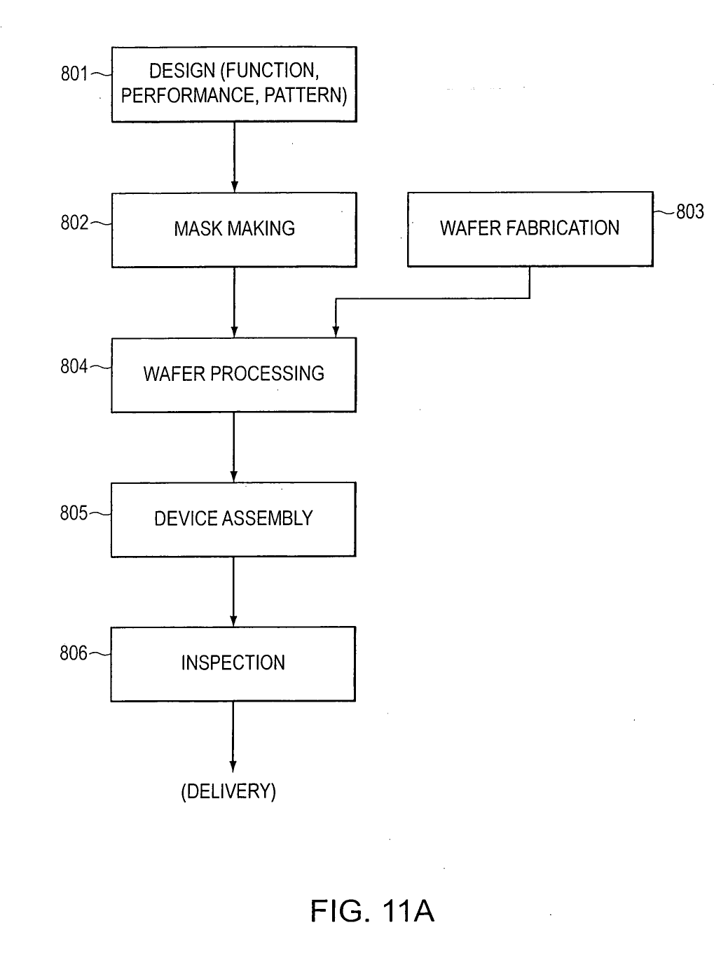

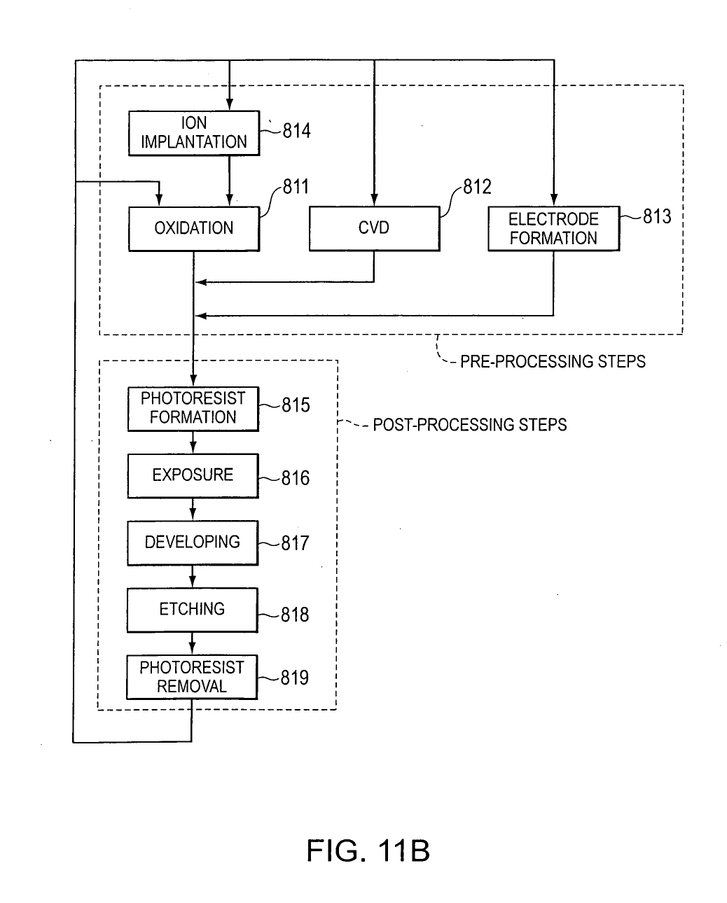

Semiconductor devices can be fabricated using the above described systems, by the process shown generally in FIG. 11A. In step 801 the device's function and performance characteristics are designed. Next, in step 802, a mask (reticle) having a pattern is designed according to the previous designing step, and in a step 803, a wafer is made from a silicon material. The mask pattern designed in step 802 is exposed onto the wafer from step 803 in step 804 by a photolithography system described hereinabove in accordance with aspects of the invention. In step 805, the semiconductor device is assembled (including the dicing process, bonding process and packaging process). Finally, the device is then inspected in step 806.

FIG. 11B illustrates a detailed flowchart example of the above-mentioned step 804 in the case of fabricating semiconductor devices. In FIG. 11B, in step 811 (oxidation step), the wafer surface is oxidized. In step 812 (CVD step), an insulation film is formed on the wafer surface. In step 813 (electrode formation step), electrodes are formed on the wafer by vapor deposition. In step 814 (ion implantation step), ions are implanted in the wafer. The above mentioned steps 811-814 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 815 (photoresist formation step), photoresist is applied to a wafer. Next, in step 816 (exposure step), the above-mentioned exposure device is used to transfer the circuit pattern of a mask (reticle) to a wafer. A liquid removal apparatus as described herein is then used to remove any immersion liquid remaining on the exposed wafer. Then in step 817 (developing step), the exposed wafer is developed, and in step 818 (etching step), parts other than residual photoresist (exposed material surface) are removed by etching. In step 819 (photoresist removal step), unnecessary photoresist remaining after etching is removed. Multiple circuit patterns are formed by repetition of these preprocessing and post-processing steps.

A photolithography system (an exposure apparatus) according to the embodiments described herein can be built by assembling various subsystems in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes providing mechanical interfaces, electrical circuit wiring connections and air pressure plumbing connections between each subsystem. Each subsystem also is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

While the invention has been described with reference to preferred embodiments thereof, it is to be understood that the invention is not limited to the preferred embodiments or constructions. The invention is intended to cover various modifications and equivalent arrangements. In addition, while the various elements of the preferred embodiments are shown in various combinations and configurations, that are exemplary, other combinations and configurations, including more, less or only a single element, are also within the spirit and scope of the invention.

What is claimed is:

1. An apparatus for removing immersion liquid from a surface of a substrate that has been subjected to immersion lithographic exposure, the apparatus comprising:
a temperature control unit that controls a temperature of the substrate to create a temperature gradient across at least a portion of the surface of the substrate such that a first portion of the surface of the substrate has a first temperature that is higher than a second temperature of a second portion of the surface of the substrate; and
a liquid collection unit that collects the immersion liquid from the substrate.

2. The apparatus according to claim 1, wherein the liquid collection unit is disposed adjacent to the second portion of the substrate to collect the immersion liquid from the second portion of the substrate.

3. The apparatus according to claim 1, wherein the temperature control unit includes a heating unit, and the temperature control unit controls the temperature of the substrate by heating the first portion with the heating unit.

4. The apparatus according to claim 3, wherein the substrate is supported on a holder, and the heating unit is disposed in the holder so as to apply heat to a surface of the substrate that is opposite to the surface of the substrate from which the immersion liquid is to be removed.

5. The apparatus according to claim 4, wherein the heating unit is disposed in the holder adjacent a position corresponding to a center of the substrate held by the holder.

6. The apparatus according to claim 4, wherein the holder is part of a substrate table.

7. The apparatus according to claim 1, wherein the first portion of the surface of the substrate is adjacent a first side of the substrate and the second portion of the surface of the substrate is adjacent a second, opposite side of the substrate, and the temperature control unit controls the temperature of the substrate such that the temperature gradient, from a higher temperature to a lower temperature, extends across the substrate from the first side to the second side.

8. The apparatus according to claim 1, wherein the first portion of the surface of the substrate is adjacent a central portion of the substrate and the second portion of the surface of the substrate is adjacent a periphery of the substrate, and the temperature control unit controls the temperature of the substrate such that the temperature gradient, from a higher temperature to a lower temperature, extends radially outward from the central portion of the substrate toward the periphery of the substrate.

9. The apparatus according to claim 1, further comprising a liquid removal device that removes the immersion liquid from the substrate by causing the immersion liquid to move from the first portion toward the second portion separately from any immersion liquid movement caused by the temperature gradient.

10. The apparatus according to claim 9, wherein the liquid removal device includes a blower that blows gas onto the substrate.

11. The apparatus according to claim 9, wherein the liquid removal device moves the substrate to cause the immersion liquid to move.

12. The apparatus according to claim 11, wherein the liquid removal device spins the substrate.

13. The apparatus according to claim 11, wherein the liquid removal device inclines the substrate.

14. An exposure apparatus comprising:
a projection system;
a substrate stage that holds a substrate adjacent to a final optical element of the projection system with a gap between the final optical element and substrate held by the substrate stage, an immersion liquid being supplied to at least a portion of the gap such that an image of a pattern is projected through the projection system and the immersion liquid onto a surface of the substrate; and
the apparatus defined in claim 1 disposed in the exposure apparatus adjacent to the substrate stage.

15. An exposure system comprising:
an exposure apparatus that forms an image of a pattern onto a surface of a substrate by projecting an exposure beam through a projection system and an immersion liquid onto a resist formed on the surface of the substrate;
a processing apparatus that processes the exposed substrate; and
the apparatus of claim 1 disposed between the exposure apparatus and the processing apparatus to remove the immersion liquid remaining on the substrate from the surface of the substrate before the exposed substrate is transferred into the processing apparatus.

16. The exposure system according to claim 15, wherein the processing apparatus is a coater-developer.

17. An exposure system comprising:
an exposure apparatus including (i) a projection system, (ii) a substrate stage that holds a substrate adjacent to a final optical element of the projection system with a gap between the final optical element and the substrate held by the substrate stage, and (iii) an immersion liquid supply and recovery apparatus that supplies and recovers an immersion liquid to/from at least a portion of the gap at least during an exposure operation such that an image of a pattern is projected through the projection system and the immersion liquid onto a surface of the substrate; and
a liquid removal apparatus disposed adjacent to the exposure apparatus, the liquid removal apparatus receiving the exposed substrate from the exposure apparatus, the liquid removal apparatus including a temperature control unit that controls a temperature of the substrate to create a temperature gradient across at least a portion of the surface of the substrate such that a first portion of the surface of the substrate has a first temperature that is higher than a second temperature of a second portion of the surface of the substrate to cause immersion liquid remaining on the substrate after the exposure operation to move from the first portion toward the second portion.

18. The exposure system according to claim 17, wherein the liquid removal apparatus further comprises:
a liquid collection unit that collects the immersion liquid from the substrate.

19. The exposure system according to claim 17, wherein the liquid removal apparatus is disposed in a chamber that also contains the exposure apparatus.

20. The exposure system according to claim 17, wherein the liquid removal apparatus is disposed in a chamber different from a chamber in which the exposure apparatus is disposed.

21. The exposure system according to claim 20, further comprising:
a processing apparatus disposed adjacent to the liquid removal apparatus, the processing apparatus processes the exposed substrate after the remaining liquid has been removed from the substrate by the liquid removal apparatus.

22. The exposure system according to claim 21, wherein the processing apparatus is a coater-developer.

23. The exposure system according to claim 17, wherein the temperature control unit includes a heating unit, and the temperature control unit controls the temperature of the substrate by heating the first portion with the heating unit.

24. The exposure system according to claim 23, wherein the liquid removal apparatus includes a holder that holds the substrate, and the heating unit is disposed in the holder so as to apply heat to a surface of the substrate that is opposite to the surface of the substrate from which the immersion liquid is to be removed.

25. The exposure system according to claim 24, wherein the heating unit is disposed in the holder adjacent a position corresponding to a center of the substrate held by the holder.

26. The exposure system according to claim 17, wherein the first portion of the surface of the substrate is adjacent a first side of the substrate and the second portion of the surface of the substrate is adjacent a second, opposite side of the substrate, and the temperature control unit controls the temperature of the substrate such that the temperature gradient, from a higher temperature to a lower temperature, extends across the substrate from the first side to the second side.

27. The exposure system according to claim 17, wherein the first portion of the surface of the substrate is adjacent a central portion of the substrate and the second portion of the surface of the substrate is adjacent a periphery of the substrate, and the temperature control unit controls the temperature of the substrate such that the temperature gradient, from a higher temperature to a lower temperature, extends radially outward from the central portion of the substrate toward the periphery of the substrate.

28. The exposure system according to claim 17, wherein the liquid removal apparatus further comprises a liquid removal device that removes the immersion liquid from the substrate by causing the immersion liquid to move from the first portion toward the second portion separately from any immersion liquid movement caused by the temperature gradient.

29. The exposure system according to claim 28, wherein the liquid removal device includes a blower that blows gas onto the substrate.

30. The exposure system according to claim 28, wherein the liquid removal device includes an actuator to move the substrate to cause the immersion liquid to move.

31. The exposure system according to claim 30, wherein the actuator spins the substrate.

32. The exposure system according to claim 30, wherein the actuator inclines the substrate.

33. A method for removing immersion liquid from a surface of a substrate that has been subjected to immersion lithographic exposure, the method comprising:
creating a temperature gradient across at least a portion of the surface of the substrate such that a first portion of the surface of the substrate has a first temperature that is higher than a second temperature of a second portion of the surface of the substrate; and
collecting the immersion liquid from the substrate.

34. The method according to claim 33, wherein the liquid is collected by a liquid collection unit disposed adjacent to the second portion of the substrate to collect the immersion liquid from the second portion of the substrate.

35. The method according to claim 33, wherein the temperature gradient is created by heating the first portion with a heating unit.

36. The method according to claim 35, wherein the substrate is supported on a holder, and the heating unit is disposed in the holder so as to apply heat to a surface of the substrate that is opposite to the surface of the substrate from which the immersion liquid is to be removed.

37. The method according to claim 36, wherein the heating unit is disposed in the holder adjacent a position corresponding to a center of the substrate held by the holder.

38. The method according to claim 33, wherein the first portion of the surface of the substrate is adjacent a first side of the substrate and the second portion of the surface of the substrate is adjacent a second, opposite side of the substrate, and the temperature of the substrate is controlled such that the temperature gradient, from a higher temperature to a lower temperature, extends across the substrate from the first side to the second side.

39. The method according to claim 33, wherein the first portion of the surface of the substrate is adjacent a central portion of the substrate and the second portion of the surface of the substrate is adjacent a periphery of the substrate, and the temperature of the substrate is controlled such that the temperature gradient, from a higher temperature to a lower temperature, extends radially outward from the central portion of the substrate toward the periphery of the substrate.

40. The method according to claim 33, further comprising removing the immersion liquid from the substrate by causing the immersion liquid to move from the first portion toward the second portion separately from any immersion liquid movement caused by the temperature gradient.

41. The method according to claim 40, wherein the removing includes blowing gas onto the substrate.

42. The method according to claim 40, wherein the removing includes moving the substrate to cause the immersion liquid to move.

43. The method according to claim 42, wherein the moving includes spinning the substrate.

44. The method according to claim 42, wherein the moving includes inclining the substrate.

45. An exposure method comprising:
transferring an image of a pattern onto a substrate while the substrate is held by a substrate stage that holds the substrate adjacent to a final optical element of a projection system with a gap between the final optical element and substrate held by the substrate stage, an immersion liquid being supplied to at least a portion of the gap such that the image of the pattern is projected through the projection system and the immersion liquid onto a surface of the substrate during an exposure operation; and
removing immersion liquid remaining on the substrate after the exposure operation according to the method of claim 33.

46. The method according to claim 45, wherein the removing step is performed in a chamber in which the transferring takes place.

47. The method according to claim 45, wherein the removing step is performed in a chamber different from a chamber in which the transferring takes place.

48. The method according to claim 45, further comprising processing the substrate after the removing step.

49. The method according to claim 48, wherein the processing is performed by a coater-developer.
